(19) United States
(12) Patent Application Publication
(10) Pub. No.: US 2022/0391819 A1
(43) Pub. Date: Dec. 8, 2022

(54) MATCHMAKING SYSTEM AND METHOD USING A COMBINATION OF COMPUTER-IMPLEMENTED ALGORITHMS AND HUMAN ANALYSIS

(71) Applicant: Gallant Match, LLC, Santa Monica, CA (US)

(72) Inventors: Constance Curtis, Santa Monica, CA (US); Andrea Gallego, Santa Monica, CA (US)

(21) Appl. No.: 17/833,797

(22) Filed: Jun. 6, 2022

Related U.S. Application Data
(60) Provisional application No. 63/197,104, filed on Jun. 4, 2021.

(51) Int. Cl. G06Q 10/06; G06Q 50/00

(52) U.S. Cl. CPC G06Q 10/063118; G06Q 50/01

(57) ABSTRACT

In a system and method of the present disclosure, clients select potential matches through an application, such as a browser-based application executed on a computing device, or a mobile application executed on a mobile computing device such as a smart phone. Through the use of automation, first human and then automated (i.e., computer-implemented) matchmakers simultaneously reach out to the potential match to vet on behalf of the clients. The system and method also uses data to suggest other matches that have a high likelihood of success for being liked by the client will like, based on their historical selections and interactions through the application.

### CROSS-REFERENCES TO RELATED APPLICATIONS

This application claims the benefit of U.S. Provisional Application No. 63/197,104, entitled “MATCHMAKING SYSTEM AND METHOD USING A COMBINATION OF COMPUTER-IMPLEMENTED ALGORITHMS AND HUMAN ANALYSIS” and filed Jun. 4, 2021, the entirety of which is incorporated by reference herein.

### TECHNICAL FIELD

The subject matter described herein relates to matchmaking among persons, and more particularly to a matchmaking system and method using a combination of computer-implemented algorithms and human intervention and analysis.

### BACKGROUND

Users waste countless hours of valuable time with online dating. Online dating is time-consuming. Users spend hours searching for someone to connect with, and once connected with a person, exhaust hours talking to this person online and researching the person's online presence to determine whether they want to meet in person.

After investing all that time, there is no guarantee that the user will meet them in person. For instance, online “ghosting” is a problem: valuable time goes into searching and vetting a potential date, whereupon the connection or online profile of the potential date suddenly disappears. Additionally, many online profiles are misleading. A user can do all the “googling” and vetting they want, but there is no guarantee their target's profile, bio or pictures are real. If and when an in-person meeting finally happens, it is typically very disappointing and very different from the online profile.

Traditional matchmakers, i.e., using human agents, may provide better and more reliable results, but such traditional matchmakers are too expensive, too slow, and usually limited to their own database of clients. Traditional matchmakers have old-school business models. Their models have no user-integrated technology to allow their clients to select potential matches through a digital platform. Further, traditional matchmaking has never been successfully implemented in a mobile application.

There are no efficient products in the dating space for business professionals. Dating apps and websites are all self-service. Users have to set up their own dating profiles, search themselves for potential matches, vet their potential matches and schedule their own dates. This is an extremely time-consuming process for which clients, particularly business professionals, do not have time.

### SUMMARY

This document describes a digital matchmaking system and method, and associated online service, that bridges the gap between conventional dating apps and traditional offline matchmakers.

In some aspects, a system and method in accordance with this disclosure includes an application configured to be executed on a mobile device. The application includes a set of application programming interfaces to receive data related to a plurality of clients seeking a match, the data including a dataset of aspects, characteristics and affinities of each of the plurality of clients and social media information of each of the plurality of clients. The application further includes a scoring engine configured to generate a weighted score for each of the plurality of clients, the weighted score being used by the application to generate a ranking of each of the plurality of clients, the ranking representing a potential match with each other of the plurality of clients.

The system further includes a server computer having a human interface, the human interface providing a portal for a human matchmaker to assess the weighted score and the ranking of each of the plurality of clients to develop a model of matchmaking between pairs of the plurality of clients. The server computer further includes a machine learning and artificial intelligence module configured to process the model developed by the human matchmaker to generate a list of matches between the pairs of the plurality of clients, the list being based on predictive algorithms of a likeliness of success.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to a matchmaking system and method using a combination of computer-implemented algorithms and human analysis, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIGS. 1 and 2 illustrate a graphical representation of a person and their associated aspects, characteristics, affinities and other attributes;

FIG. 3 illustrates examples of features using the largest personality database ever created;

FIG. 4 is a block diagram of a matchmaker app in accordance with implementations described herein; and

FIG. 5 illustrates a system and associated workflows for executing a search for matching a client with a person, in accordance with implementations described herein.

When practical, similar reference numbers denote similar structures, features, or elements.

### DETAILED DESCRIPTION

This document describes a digital matchmaking system and method. The systems and methods described herein can be implemented as an online service, such as a website or local application on a computing device, such as a laptop or desktop computer, or a mobile app for execution by a mobile computing device. The systems and methods leverage the gap of dating and matchmaking between conventional dating apps and traditional offline matchmakers of dating, creating a more efficient way for business professionals to be matched and to date.

In some preferred implementations, each client of the service is provided their own personal matchmaker who assists with searching, vetting and scheduling a date via a proprietary matchmaking process. The provision and assignment of the personal matchmaker saves clients significant amounts of their time that they would have spent online when doing it all themselves. The system and method described herein employs user-integrated technology, artificial intelligence (AI), and machine learning (ML) that complements, and eventually overtakes, human model training.

In preferred implementations, clients select potential matches through an application (hereinafter “app”), such as a browser-based application executed on a computing device, or a mobile app executed on a mobile computing device such as a smart phone. Through the use of automation, first human and then automated (i.e., computer-implemented) matchmakers simultaneously reach out to the potential match to vet on behalf of the clients. The system and method also uses data to suggest other matches that have a high likelihood of success for being liked by the client will like, based on their historical selections and interactions through the app.

While occasionally the perfect match for a client is already stored and present in the system's internal database, sometimes such perfect match may not be. Accordingly, in some implementations, human and/or computer-implemented matchmakers search outside of such internal database, to virtually any data source globally, to find the best potential match for the client. While present human-only matchmaking processes are not efficient or scalable, the system and method disclosed herein includes new software modules that will allow targeted and efficient, and scalable, searching of the world wide web for potential matches. These software modules therefore allow the system and method to provide the best list of potential matches for clients, which will ensure the best level of service and customer satisfaction.

The data gathered by the system can include, without limitation, data sources such as social media, professional profiles, rankings, political affiliations, geographic sources, Meyers-Briggs or similar personality tests (preferably taken online by target dates), and other data sources.

### Next Best Partner Algorithm

The system and method of the present disclosure utilizes a “next best partner” algorithm, which is a specialized variant of next-best-action marketing (also known as best next action or next best activity or recommended action), which is a customer-centric marketing algorithm that considers different commercial actions that can be taken for a specific customer, and decides on the “best” action (i.e. an offer to the customer, proposition, service, etc.). In the context of the present system and method, the next best partner algorithm is determined by a client's interests and needs on the one hand, and business objectives, policies, etc. of the system on the other. The system's matchmaking using the next best partner algorithm is a new approach to matchmaking that not only uses more data than any other matchmaking service, but also uses new feature to help human matchmakers leverage AI to find partners that are most likely to succeed based on a ranking according to a score, and to which a “currency” can be applied.

The system and method use proprietary predictive and prescriptive algorithms to produce the next best partner. Predictions are be based on unique features that will feed into prescriptions and rankings of matches for each client. Feature engineering is being done on billions of data points and images all over the world, to allow the system to determine which features matter when people are looking for life partners.

### Romantic Personality Assessment

The system's personality assessment is a self-report questionnaire differing psychological preferences in how people perceive themselves and others. The self-report questionnaire assesses a person's beliefs, attitude, and feelings on multiple subjects, both personal and professional. The test assesses the data collected and link answers to personality traits. These personality traits will then be linked to an individual's career, activities, beliefs, etc. For example, a client looking for their next best partner to be a protective, warm, gentle, patient, logical, generous, philanthropist, devoted caretaker who enjoys being helpful to others, would be matched with a person who is an elementary teacher, nurse, bank teller, or financial clerk, who also is involved in charity work, likes to play chess and is a single parent. This type of multi-variate and multi-dimensional matching process provided by the system and method described herein is specifically configured to ensure a suitable and best match, which otherwise would take the client many years to find and settle on.

### Unique Data Sets

The system employs the largest personality database of any dating or matching app, configured to combine professional, social, romantic, and other personal attributes. This allows the system to create the best and most accurate representation of a person, without needing client input, such as a swipe right/left as required for some conventional dating apps. The personality data sets can include, without limitation, aspects, characteristics, and affinities such as:
location
education level
career
political affiliation
own home/rent home
income level
net worth
pets
travel
activities/hobbies
movies/television shows
articles/reading Material
physical attributes
religion
drinking
smoking
Recreational drug use
Ethnicity
Personality (sentiment analysis)
relationship status
kids/want kids
sexual orientation
images
Similar networks/circles
Personality score
System score (explained further below)

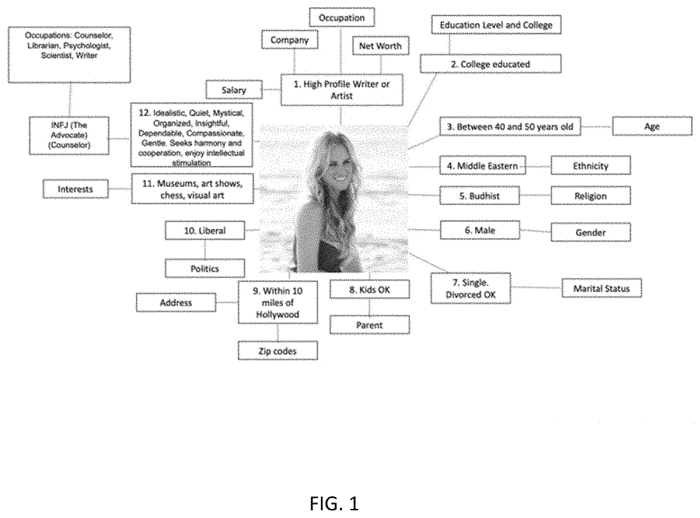

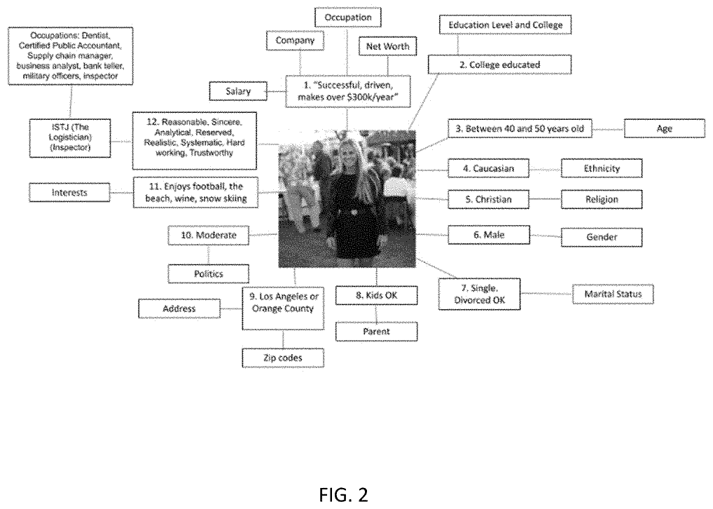

FIGS. 1 and 2 illustrate a graphical representation of a person and their associated aspects, characteristics, affinities and other attributes.

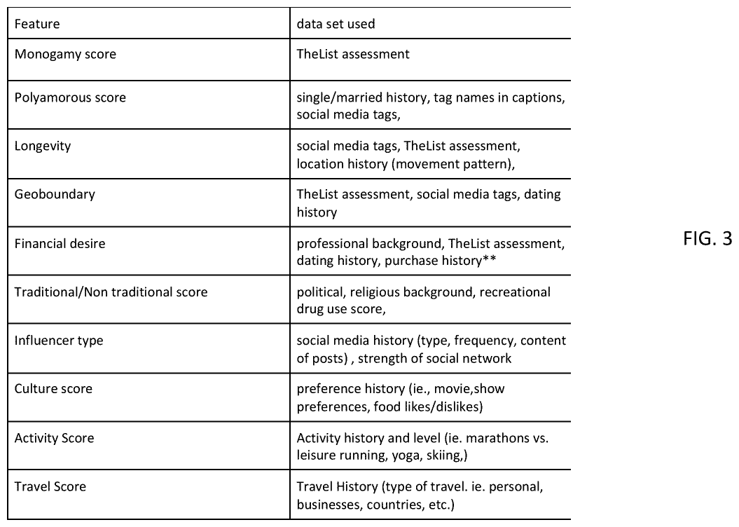

The collected data is protected by all standard data privacy protection laws, both domestically and internationally. The collected data sets are combined using proprietary weights and algorithmic methods (as explained further below) to create unique parameters that will allow the algorithm to rank and match partners to one another with a high degree of certainty, and for long-term romantic partnership success. In addition to manual methods of data-driven feature creation, the system uses automated methods to allow artificial intelligence (AI) to also find and create new features based on the data the model is given. Examples of features using the largest personality database ever created are shown in FIG. 3.

### Scores

The system calculates scores by assigning weights to given data points according to the particular score. For example, in the Traditional/Nontraditional score, weights are applied as to whether or not someone consistently uses recreational drugs, drinks, or smokes. Weights are also applied to sentiment analysis in text where sentiment shows “bucking the trend.” For example, if an Instagram® post states “This is so basic!”—this is vernacular for the individual in question stating their opinion that someone is being too trendy or status quo. The algorithms of the system and method are configured specifically and deeply assess these types of data points. In some exemplary implementations, the weights applied can be positive and high positive for traditional data points and negative and high negative for non-traditional data points.

Therefore, in these examples, someone with a score of +20 is much more traditional than someone with a score of −20, who would be considered non-traditional. Scores can be applied to any and all aspects, characteristics, affinities and other attributes of persons in the database, or who have registered as users of the system. When matching individuals, the correlation algorithm uses distance metrics to clearly ensure that two persons with a +20 and −20 score, respectively, are not matched. Someone with a −2 may be matched with someone who has a +3 score, given the shorter “distance,” or numerical difference, between scores.

### Ensemble

Ensemble methods are employed by the system to get the most accurate results for matchmakers to review. Ensemble methods are defined as techniques that create multiple models, and then combine them to produce a single model with improved results. Ensemble methods usually produce more accurate solutions than a single model would, as in most cases of machine learning. In addition to using ensemble methods, the system and method are configured for weighting certain features in each model more than others for greater accuracy. For example, the following features of a model can be weighted higher, based at least in part on historical measures of accuracy and effectiveness: Professional background, political and religious affiliation, recreational drug use, alcohol and smoking preferences are weighted more on average than movie preferences, travel preferences, etc.

As part of the ensemble methods used by the system, the machine learning algorithms can use bagging and/or boosting and/or stacking methods. Bagging is a method of merging the same type of predictions. Boosting is a method of merging different types of predictions. Bagging decreases variance, not bias, and solves over-fitting issues in a model, while boosting decreases bias, not variance. In other words, bagging is a way to decrease the variance in the matchmaking prediction by generating additional data for training from a dataset using combinations with repetitions to produce multi-sets of the original data. Boosting is an iterative technique which adjusts the weight of an observation based on the last classification.

Bagging, that often considers homogeneous weak learners, learns them independently from each other in parallel and combines them following some kind of deterministic averaging process. Boosting, that often considers homogeneous weak learners, learns them sequentially in a very adaptative way (a base model depends on the previous ones) and combines them following a deterministic strategy. Stacking, that often considers heterogeneous weak learners, learns them in parallel and combines them by training a meta-model to output a prediction based on the different weak models' predictions.

The system and method's next best partner algorithm is configured to send outputs to a human matchmaker to confirm, augment and decide against. Accordingly, the service provided by the system and method described herein is not fully automated: while AI and ML-enabled, the system does not replace a human matchmaker as the ultimate arbiter of a successful pairing.

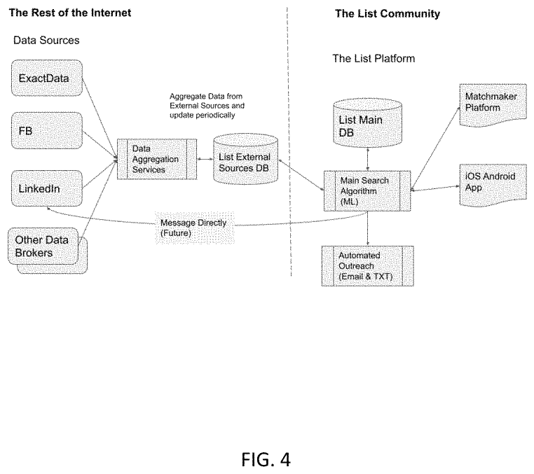

FIG. 4 is a block diagram of a matchmaker app in accordance with implementations described herein. In some implementations, the software design is micro-services-based. Services can include, without limitation:
Data ingestion—A set of APIs that ingest data of any type and load into an Amazon® S3 bucket (or the like) to prepare for processing;
Lambda ETl—A serverless process that has a data pipeline code to transform the data into tabular data to allow for storage and feature generation;
Data storage—Data is finally stored in a SQL-like database such as Amazon® RDS or Posgres or the like;
Data preparation—Data is manipulated and prepared using Python to allow for features to be generated and prepared for the model;
Feature store—Features are stored in a tabular format in a database;
Machine learning service—A server that houses Python, Jupyter, and other open-source services as well as the proprietary algorithm(s) described above. This is the most memory intensive service;
Model API—an interface that allows scores to be pulled from the matchmaker's user interface and visualized in a web-based UI where matchmaker can assess model outcome and determine if the match is really a match or not;
Matchmaking application—a web server with a user interface (UI) for the matchmaker to use
Application—web based app portal for the clients—The clients do not see the matchmakers' application, which is where the model outputs are sent.

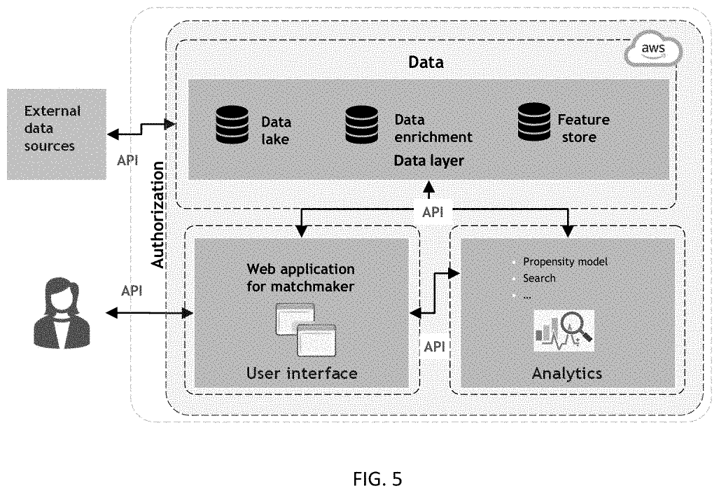

FIG. 5 illustrates a system and associated workflows for executing a search for matching a client with a person, in accordance with implementations described herein. The system provides for powerful search and collaborative filtering engine for matchmakers. The system includes a feature store. The feature store is all data is taken in, and unique features are created that help rank and filter potential matches. “Next best action” models are used to determine the next best match the client is likely to date. Smart searching filters are available to allow match makers to quickly find the top-ranking candidates. Collaborative filtering can be used to help assess the right concierge services (i.e., “these candidates like this restaurant more than that other restaurant”).

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A matchmaking system comprising:
an application configured to be executed on a mobile device, the application including a set of application programming interfaces to receive data related to a plurality of clients seeking a match, the data including a dataset of aspects, characteristics and affinities of each of the plurality of clients and social media information of each of the plurality of clients, the application further including a scoring engine configured to generate a weighted score for each of the plurality of clients, the weighted score being used by the application to generate a ranking of each of the plurality of clients, the ranking representing a potential match with each other of the plurality of clients; and
a server computer having a human interface, the human interface providing a portal for a human matchmaker to assess the weighted score and the ranking of each of the plurality of clients to develop a model of matchmaking between pairs of the plurality of clients, the server computer further having a machine learning and artificial intelligence module configured to process the model developed by the human matchmaker to generate a list of matches between the pairs of the plurality of clients, the list being based on predictive algorithms of a likeliness of success.

2. The system in accordance with claim 1, wherein the predictive algorithms employed by the server computer include a next-best-partner algorithm.

3. The system in accordance with claim 1, wherein the application further includes a personality assessment, wherein the personality assessment is an interactive questionnaire to assess each client's beliefs, attitudes, and feelings on a number of subjects.

4. The system in accordance with claim 1, further comprising a personality database connected with the application and the server computer, the database storing the dataset of aspects, characteristics and affinities of each of the plurality of clients and the social media information of each of the plurality of clients for access by the application and the server computer.
